(19) United States
(12) Patent Application Publication
(10) Pub. No.: US 2009/0030611 A1
(43) Pub. Date: Jan. 29, 2009

(54) GPS Navigation Device With Car Rear-Viewing Function

(76) Inventor: Jeong-Shiun Chen, Zhonghe (TW)

Correspondence Address: LIN & ASSOCIATES INTELLECTUAL PROPERTY, INC., P.O. BOX 2339, SARATOGA, CA, 95070-0339, US

(21) Appl. No.: 11/943,592

(22) Filed: Nov. 21, 2007

(30) Foreign Application Priority Data
Jul. 25, 2007 (TW) 96212182

(51) Int. Cl. G01C 21/26; G01S 5/00

(52) U.S. Cl. 701/213

(57) ABSTRACT

A GPS navigation device with a car rear-viewing function is disclosed herein, which includes a monitor, a GPS navigation module receiving a GPS navigation information and providing it to the monitor, a car rear-viewing module providing a car rear image from a camera to the monitor, a switch unit, and a micro control unit. When the shift lever of the car is located in a reverse gear position, the micro control unit sends a switch command to the switch unit to allow the car rear-viewing module to transmit the car rear image to the monitor. In contrast, when the shift lever is not located in the reverse gear position, the monitor is switched to be controlled by the GPS navigation module for displaying the navigation information. Therefore, there is no need to install an additional monitor for displaying the GPS navigation information and the car rear image information, respectively.

### BACKGROUND OF THE INVENTION

1. Field of the Invention

The present invention relates to a global positioning system (GPS) navigation device, which can display a car rear image on a monitor

2. The Prior Arts

With the increasing concerns in driving safety and convenience, it is desired to quip with a global positioning system and a car rear-viewing system on cars. And many patents related to the systems were filed.

To assist drivers to reverse their cars, Taiwanese Patent Publication No. 564,829 disclosed an automobile omnidirectional image device, which provides the drivers images around the car to help the drivers to safely reverse car without any blind spots. Taiwanese Patent Publication No. I232,820 disclosed a wireless car reverse radar device with a plurality of image channels, which can display a plurality of car rear images on a single monitor. Taiwanese Patent Publication No. I229,645 disclosed an auxiliary car parking device, which not only provides the drivers a car rear image, but also helps the drivers to determine, with the assistance of a sensing and automatic judging system, if the car is able to be parked in a parking space.

The Global Positioning System (GPS) has successfully been applied in the fields of navigation, time-giving, and high precise measurement. The positioning principle of the GPS is that the satellites constantly transmit the Ephemeris and time information to a receiver of the GPS, which is further calculated to get a three-dimensional position and direction, movement speed, and time information of the receiver on the basis of the received information. In general, after the GPS receiver receives a positioning information, it is transmitted through a Bluetooth communication device to a positioning information analyzer, which is an electronic device with operation function, such as a PDA, to calculate a relative position according to a pre-built graph and information analysis, and graphically display it on a monitor to let a user clearly know where he/she is.

Conventionally, if a driver intends to obtain a GPS navigation information and a car rear image information at the same time, the car shall be equipped with both GPS navigation device and car rear-viewing device, and at least two monitors displaying their respective information.

### SUMMARY OF THE INVENTION

A primary objective of the present invention is to provide a GPS navigation device with a car rear-viewing function, which is installed on a car and can provide a GPS navigation information or a car rear image information at a right time based on the position of a shift lever of the car. There is no need to provide an additional monitor to display the GPS navigation information and the car rear image information, respectively.

In order to achieve the above objective, the GPS navigation device with the car rear-viewing function in accordance with the present invention includes a monitor, a GPS navigation module receiving a GPS navigation information and providing it to the monitor, a car rear-viewing module providing a car rear image from a camera to the monitor, a switch unit, and a micro control unit. When the shift lever of the car is located in a reverse gear position, the micro control unit sends a switch command to the switch unit to allow the car rear-viewing module to transmit the car rear image to the monitor. In contrast, when the shift lever is not located in the reverse gear position, the monitor is switched to be controlled by the GPS navigation module for displaying the navigation information. Therefore, there is no need to install an additional monitor for displaying the GPS navigation information and the car rear image information, respectively.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing that a GPS navigation device with a car rear-viewing function is installed on a car, in accordance with a preferred embodiment of the present invention; and

FIG. 2 is a schematic diagram showing a structure of the GPS navigation device with the car rear-viewing function in accordance with the present invention.

### DETAILED DESCRIPTION OF THE PREFERRED EMBODIMENT

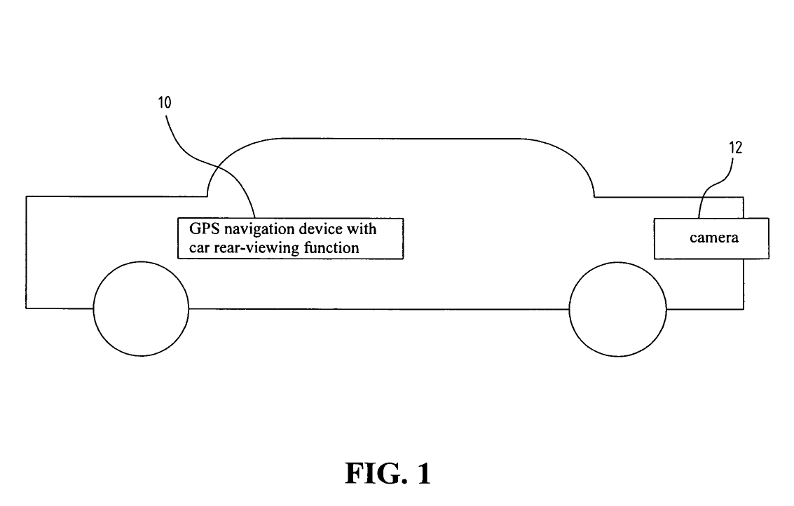

Referring to FIG. 1, a GPS navigation device 10 in accordance with the present invention, which is installed on a car, can receive a car rear image by means of a wireless or wired communication device from a camera 12 disposed on a rear of the car.

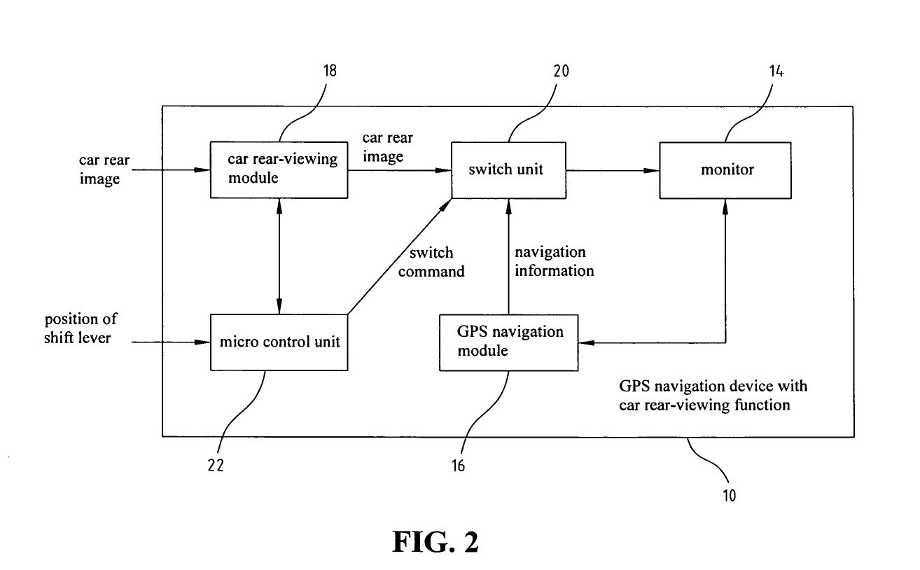

Referring to FIG. 2, the GPS navigation device 10 with a car rear-viewing function in accordance with the present invention includes a monitor 14, a GPS navigation module 16 for receiving a GPS navigation information and providing it to the monitor, a car rear-viewing module 18 providing a car rear image from the camera 12 (see FIG. 1) to the monitor, a switch unit 20, and a micro control unit 22. The micro control unit 22 can send a switch command to the switch unit 20 if a shift lever of the car is located on a reverse gear position.

Briefly, in accordance with the GPS navigation device 10 of the present invention, when the micro control unit 22 detects the shift lever is located in the reverse gear position, the micro control unit 22 sends a switch command to the switch unit 20 to allow the car rear-viewing module 18 to transmit the car rear image to the monitor 14. In contrast, when the micro control unit 22 does not detect the shift lever is located in the reverse gear position, the monitor 14 is switched to be controlled by the GPS navigation device 16 for displaying the navigation information. Therefore, there is no need to install an additional monitor for displaying the GPS navigation information and the car rear image information, respectively. In other words, only in reversing the car, it is needed for a driver to have the car rear image information. At this time, the monitor 14 displays the car rear image. When the shift gear is located in other gear positions, the monitor 14 displays the navigation information. The following will describe how to switch the GPS navigation module 16 and the car rear-viewing module 18.

With reference to FIG. 2, the switch unit 20 is electronically connected to the GPS navigation module 16 and the car rear-viewing module 18. According to the switch command from the micro control unit 22, the switch unit 20 communicates the GPS navigation module 16 with the monitor 14, or communicates the car rear-viewing module 18 with the monitor 14. More specifically, when the shift lever is located in the reverse gear position, the switch unit 20 communicates the car rear-viewing module 18 with the monitor 14 to allow the car rear image be transmitted from the car rear-viewing module 18 to the monitor 14. In contrast, when the shift lever is located in other gear positions, the switch unit 20 communicates the GPS navigation module 16 with the monitor 14 to allow the navigation information to be transmitted from the GPS navigation module 16 to the monitor 14.

As shown in FIG. 1, a power supply of the camera 12 is connected with a reverse light on the rear of the car. When the shift lever is located in the reverse gear position, not only is the reverse light turned on, but also the camera 12 is activated to transmit the car rear image to the monitor 12 of the GPS navigation device of the present invention.

To prevent from the failure of displaying the car rear image on the monitor 14 in the state of communicating the car rear-viewing module 18 with the monitor 14, the micro control unit 22 has to first confirm the camera 12 is powered on, and then detect the position of the shift lever. If the micro control unit 22 confirms the camera 12 is powered off, the car rear-viewing module 18 is shut down.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A GPS navigation device with a car rear-viewing function, comprising:
a monitor;
a GPS navigation module receiving a navigation information and providing it to the monitor;
a car rear-viewing module providing a car rear image from a camera to the monitor;
a switch unit electronically connected to the GPS navigation module and the car rear-viewing module; and
a micro control unit sending a switch command, according to a position of a shift lever of a car, to the switch unit to communicate the GPS navigation module or the car rear-viewing module with the monitor.

2. The GPS navigation device as claimed in claim 1, wherein when the shift lever is not located in a reverse gear position, the switch command is to communicate the GPS navigation module with the monitor to allow the GPS navigation module to transmit the navigation information to the monitor.

3. The GPS navigation device as claimed in claim 1, wherein when the shift lever is located in the reverse gear position, the switch command is to communicate the car rear-viewing module with the monitor to allow the car rear-viewing module to transmit the car rear image to the monitor.

4. The GPS navigation device as claimed in claim 1, wherein when the shift lever is located in the reverse gear position, after the car rear-viewing module confirms to have received the car rear image from the camera, the micro control unit sends the switch command to communicate the car rear-viewing module with the monitor to allow the car rear-viewing module to transmit the car rear image to the monitor.

5. The GPS navigation device as claimed in claim 1, wherein after the micro control unit confirms that the camera is powered on, it is detected if the shift lever is located in the reverse gear position.

6. The GPS navigation device as claimed in claim 1, wherein when the micro control unit confirms that the camera is powered off, the car rear-viewing module is shut down.
